(19) United States
(12) Patent Application Publication
(10) Pub. No.: US 2010/0113133 A1
(43) Pub. Date: May 6, 2010

(54) GAMING SYSTEM AND METHOD OF GAMING

(76) Inventor: Jon McNair Leupp, Henderson, NV (US)

Correspondence Address: MCANDREWS HELD & MALLOY, LTD, 500 WEST MADISON STREET, SUITE 3400, CHICAGO, IL, 60661, US

(21) Appl. No.: 12/582,399

(22) Filed: Oct. 20, 2009

Related U.S. Application Data
(60) Provisional application No. 61/107,142, filed on Oct. 21, 2008.

(51) Int. Cl. A63F 9/24; A63F 13/00

(52) U.S. Cl. 463/20; 463/30

(57) ABSTRACT

The present invention relates to a gaming system and to a method of gaming.

A game controller is arranged to select a plurality of symbols from a set of symbols for play of a game and to control the display to display a plurality of the selected symbols at symbol positions in rows and columns forming an initial matrix of symbol combinations determining initial game outcomes.

The game controller is arranged to advance at least one of the rows and columns of symbol positions to form further symbol combinations for determining game outcomes.

Where a gaming system has a limited display area, this can allow further combinations of symbols to be determined for determining game outcomes, not limited by the available display area.

### RELATED APPLICATIONS

This application claims priority to U.S. Provisional Patent Application No. 61/107,142, having a filing date of Oct. 21, 2008, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and to a method of gaming.

It is known to provide a gaming system which comprises a game controller arranged to randomly select and cause the display of several symbols from a predetermined set of symbols and to determine a game outcome, such as a game win, based on the displayed symbols. Such gaming systems may commonly be implemented as a stepper machine provided with stepper motor driven reels with each reel carrying a reel strip presenting several symbols of the set, or a video machine wherein selected symbols are displayed on virtual reels on a graphical display device. The displayed symbol sets represent an outcome, typically presented as a matrix of symbols of N rows and M columns defined by the number of reels (usually =M) and the number of symbols presented on each reel to be included in the matrix (N). Win outcomes can occur based on symbols appearing in one or more defined horizontal lines, diagonal lines, or other predetermined way such as by symbols appearing anywhere in the display (scatter wins). As but an example Crouch, U.S. Pat. No. 5,580,053 titled “Multi-line Gaming Machine” and issued Dec. 3, 1996, the disclosure of which is incorporated by reference, discloses a gaming machine with numerous play lines. Bennett, U.S. Pat. No. 6,093,102 titled “Multiline Gaming Machine” and issued Jul. 25, 2000, the disclosure of which is also incorporated by reference, describes a structured scatter game where, rather than pay lines, pay arrangements are defined.

Typically five reels are provided on the display (although less or more may be provided). Each reel or virtual reel display is three symbols high in the display window for the reel defining a 3×5 display matrix (although, again, this may be more or less symbols high).

Because the size of the display is generally fixed, this means that a fixed number of combinations only are available to determine a game outcome. That is, there will be a fixed number of horizontal and/or diagonal line combinations of symbols available. For example, for a 3 reel machine there are typically 1 (the center row), 1-3 (all horizontal lines) or 1-5 (all horizontal lines plus two diagonals) pay lines. In many gaming systems, a player can choose whether or not to wager on one or more win lines for each play of the game. Having a limited number of symbol combinations available in the display limits the number of win lines that are available for wagering and also limits the number of combinations for determining game outcomes.

It has also been known to provide what are known in the industry as “nudge” games. For example, a game titled “Double Diamond Deluxe” manufactured and sold by IGT of Reno, Nev. is a three reel stepper game which has a single pay line at the center row of the defined 3×3 display matrix. Certain symbols have up or down pointers. If the reels stop and the display has a symbol with a down pointer above the pay line, the reel will nudge down to index the symbol to the pay line and thereby re-define the outcome. Similarly, if the reels stop and the display has a symbol with an up pointer below the pay line, the reel will nudge up to index the symbol to the pay line to re-define the outcome. If a nudge symbol in the initial display is displayed on the pay line it does not nudge either up or down. In this game blank symbols are spaced between symbols so a “nudge” does not unravel a winning combination. Thus a nudge only transforms a losing outcome to a winning outcome and only applies to specified symbols. Further, the “nudged” symbols appear and remain within the display before, during and after the “nudge” action. Additionally when symbols are nudged they only change the outcome displayed on a singular pay line.

### BRIEF SUMMARY OF THE INVENTION

In accordance with a first aspect, the present invention provides a gaming system, comprising a game controller arranged to control play of a game, and a display arranged to display a representation of play of the game, the game controller being arranged to select a plurality of symbols from a set of symbols for play of the game, and to control the display to display a plurality of the selected symbols in symbol positions in rows and columns forming an initial matrix of symbol combinations determining initial game outcomes, the game controller being arranged to advance at least one of the rows and columns of symbols to vary the matrix of symbol combinations to determine second game outcomes.

In an embodiment the step of advancing comprises replacing a displayed symbol with an additional symbol of the selected symbol set, to form the varied matrix of symbol combinations.

By “advance” is meant that one or more symbols initially appearing in the rows and columns of the display are removed from the display to provide a symbol position for the at least one additional symbol. Others of the initially displayed symbols may move symbol position as the at least one of the rows and columns of symbols is advanced, but remain within the display area. In an embodiment, more than one symbol may be removed from the display. In an embodiment, a plurality of additional symbols may be selected and displayed.

In an embodiment, the game controller is arranged to advance at least one of the rows to display the varied matrix.

In an embodiment, the rows and columns of symbol positions are represented by the display as a reel bearing the symbols, or is an actual reel bearing the symbols. The reel is advanced by emulating movement of the reel or moving the actual reel to remove symbols from the display, and display the at least one additional symbol.

In an embodiment, a plurality of additional symbols are selected and the display is controlled to advance the rows and/or columns so that the plurality of at least one additional symbol form a new row or column of symbols. In the embodiment where a symbol position is represented as reels or are actual reels, this comprises advancing all the reels so that a row of additional symbols is displayed.

In an embodiment, the game controller is arranged to control the display to advance the at least one of the rows and columns by a plurality of symbol positions. In an embodiment a plurality of additional symbols are provided, one for each of the symbol positions advanced. In an embodiment, symbol combinations are assessed for determining game outcomes for each symbol position advanced.

In an embodiment, the selection of the at least one additional symbol does not depend on a game outcome determined from symbol combinations of the initially selected symbols appearing in the display. In an embodiment, the selection of the at least one additional symbol occurs automatically as part of the same game.

In an embodiment, the present invention has the advantage that it can enable an increased number of symbol combinations for determining game outcomes. For a finite sized display, for example, which would usually only allow display of a finite number of combinations, by adding additional symbols and calculating further combinations, the number of combinations is increased for the same sized display. For example, the invention in an embodiment allows an additional row of the symbols to effectively be taken into account when determining a game outcome. In a five column by three row display of symbol positions, for example, adding five more symbols by moving the reels so that a further row of symbols appears, and then calculating game outcomes based on those additional combinations of symbols, effectively increases operation of the display to a five by four display.

In an embodiment, the game is played utilising player credit. A player may place wagers on particular combinations of symbol positions. In an embodiment, the player may also wager on additional symbol combinations that are provided by a selection of the at least one additional symbol. For example, in the embodiment where the additional symbols result in an additional row of symbols, the player may place a wager on that “win line” (i.e. the additional row).

In an embodiment, selection of an additional symbol may depend on player credit wagered. In an embodiment, the player may be able to “buy” additional symbols by betting additional credit.

In accordance with a second aspect, the present invention provides a method of gaming, comprising the steps of selecting a plurality of symbols from a set of symbols for play of a game, displaying at least a plurality of the selected symbols in symbol positions in rows and columns forming a matrix of symbol combinations for determining initial game outcomes, selecting at least one additional symbol and advancing at least one of the rows and columns displayed to introduce the additional symbol to provide a varied matrix comprising further symbol combinations determining second game outcomes.

In accordance with a third aspect, the present invention provides computer program comprising instructions for controlling a computer to implement a gaming system in accordance with the first aspect of the invention.

In accordance with a fourth aspect, the present invention provides a computer readable medium providing a computer program in accordance with the third aspect of the invention.

In accordance with a fifth aspect, the present invention provides a data signal comprising a computer program in accordance with the third aspect of the invention.

In accordance with a sixth aspect, the present invention provides a gaming system, comprising a game controller arranged to control play of a game, and a display arranged to display a representation of play of the game, the game controller being arranged to select a plurality of symbols from a set of symbols for play of the game, and to control the display to display a plurality of the selected symbols in symbol positions in rows and columns forming symbol combinations for determining game outcomes, the game controller being arranged to form further symbol combinations for determining game outcomes by combining symbols appearing in the display with selected symbols not appearing in the display.

In an embodiment, rows and columns of symbols may be represented as reels, or may be actual reels bearing the symbols. The selected symbols not displayed may notionally or actually be on portions of the reel strip that haven't entered the display area. That is, although the symbols have been selected they are hidden.

In an embodiment, this has the advantage that further symbol combinations may be achieved with a limited display.

In accordance with a seventh aspect, the present invention provides a method of gaming, comprising the steps of selecting a plurality of symbols from a set of symbols for play of a game, displaying at least a plurality of the selected symbols in symbol positions in rows and columns forming symbol combinations for determining game outcomes, and forming further symbol combinations for determining game outcomes by combining displayed symbols with selected symbols not displayed.

In accordance with an eighth aspect the present invention provides a gaming system, comprising a game controller arranged to control play of a game, and a display arranged to display a representation of play of the game, the game controller being arranged to select a plurality of symbols from a set of symbols for play of the game, and to control the display to display a plurality of the selected symbols in symbol positions in rows and columns forming symbol combinations for determining game outcomes, the game controller being arranged to select at least one additional symbol, and to control the display to advance at least one of the rows and columns of symbols to provide a symbol position for the at least one additional symbol, to form further symbol combinations for determining game outcomes, wherein the game controller is operable to advance at least one of the rows and columns of symbols irrespective of the initial game outcomes.

In accordance with a ninth aspect, the present invention provides a computer program comprising instructions for controlling a computer to implement a gaming system in accordance with the sixth aspect of the invention.

In accordance with a tenth aspect, the present invention provides a computer readable medium providing a computer program in accordance with the ninth aspect of the invention.

In accordance with an eleventh aspect, the present invention provides a data signal comprising a computer program in accordance with the ninth aspect of the invention.

In accordance with a twelfth aspect, the present invention provides a computer program comprising instructions for controlling a computer to implement a gaming system in accordance with the eighth aspect of the invention.

In accordance with a thirteenth aspect, the present invention provides a computer readable medium providing a computer program in accordance with the twelfth aspect of the invention.

In accordance with a fourteenth aspect, the present invention provides a data signal comprising a computer program in accordance with the twelfth aspect of the invention.

In accordance with a fifteenth aspect, the present invention provides a game controller arranged to control play of a game, the game controller being arranged to select a plurality of symbols from a set of symbols for play of the game, and to control a display to display a plurality of the selected symbols in symbol positions in rows and columns forming an initial matrix of symbol combinations determining initial game outcomes, the game controller being arranged to advance at least one of the rows and columns of symbols to vary the matrix of symbol combinations to determine second game outcomes.

In accordance with a sixteenth aspect, the present invention provides a game controller arranged to control play of a game, the game controller being arranged to select a plurality of symbols from a set of symbols for play of the game, and to control a display to display a plurality of the selected symbols in symbol positions in rows and columns forming symbol combinations for determining game outcomes, the game controller being arranged to form further symbol combinations for determining game outcomes by combining symbols appearing in the display with selected symbols not appearing in the display.

In accordance with a seventeenth aspect, the present invention provides a game controller arranged to control play of a game, the game controller being arranged to select a plurality of symbols from a set of symbols for play of the game, and to control a display to display a plurality of the selected symbols in symbol positions in rows and columns forming symbol combinations for determining initial game outcomes, the game controller being arranged to select at least one additional symbol, and to control the display to advance at least one of the rows and columns of symbols to provide a symbol position for the at least one additional symbol, to form further symbol combinations for determining game outcomes, wherein the game controller is operable to advance at least one of the rows and columns of symbols irrespective of the initial game outcomes.

### BRIEF DESCRIPTION OF SEVERAL VIEWS OF THE DRAWINGS

Features and advantages of the present invention will become apparent from the following description of embodiments thereof, by way of example only, with reference to the accompanying drawings, in which;

FIG. 1 is a schematic block diagram of core components of a gaming system in accordance with an embodiment of the present invention.

FIG. 2 is a diagrammatic representation of a gaming system in accordance with an embodiment of the present invention with the gaming system implemented in the form of a stand alone gaming machine;

FIG. 3 is a schematic block diagram of operative components of the gaming machine shown in FIG. 2;

FIG. 4 is a schematic block diagram of components of a memory of a gaming machine shown in FIG. 2;

FIG. 5 is a schematic diagram of a gaming system in accordance with an alternative embodiment of the present invention with a gaming system implemented over a network;

FIG. 6 is a schematic diagram of functional components of a gaming system in accordance with an embodiment of the present invention;

FIG. 7 is a representation of an example display generated by a gaming system in accordance with an embodiment of the present invention;

FIGS. 8 to 11 are representations of symbol combinations available as “win lines” of gaming machines to illustrate operation of a gaming system in accordance with an embodiment of the present invention;

FIGS. 9 and 12 are further displays generated by a gaming system in accordance with an embodiment of the present invention;

FIGS. 13 and 14 are representations showing win lines available in a gaming system in accordance with a further embodiment of the present invention; and,

FIG. 15 is a flow diagram illustrating operation of a gaming system in accordance with an embodiment of the present invention.

### DETAILED DESCRIPTION OF THE INVENTION

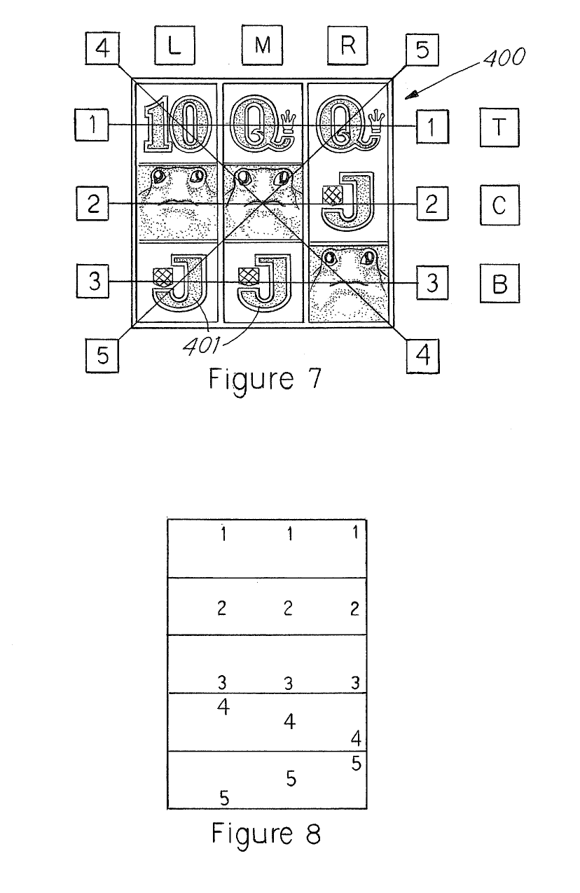

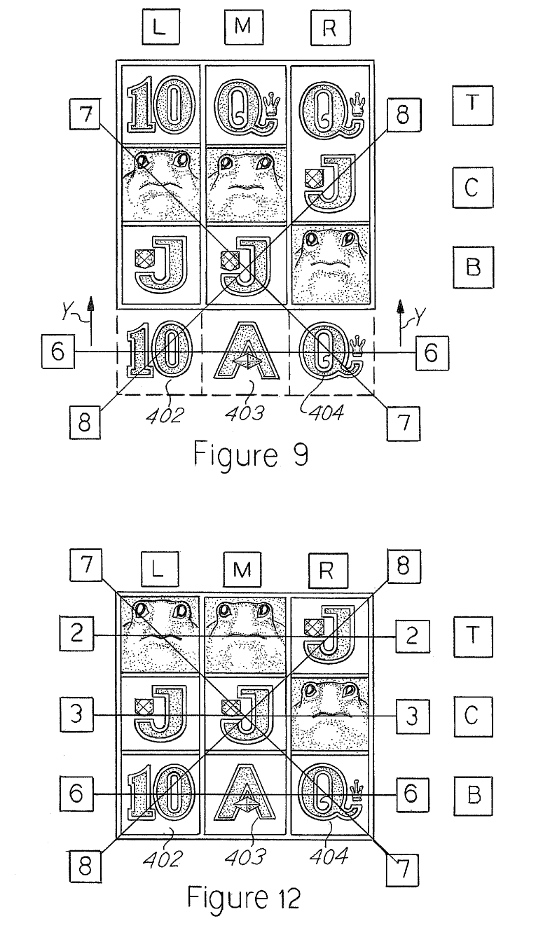

Referring to the drawings, there is a shown a gaming system arranged to implement a game in which a plurality of symbols from a set of symbols is selected and displayed in symbol positions in rows and columns. FIG. 7 shows an example display 400, with symbols 401 displayed in a plurality of rows and columns. In this embodiment, there are three columns (L, M and R) and three rows (labeled T-Top, C-Centre and B-Bottom). The display allows for a plurality of symbol combinations to determine game outcomes. In this embodiment of the invention, at least one additional symbol is selected to provide further combinations for determining game outcomes. Referring to FIG. 9, for example, three additional symbols 402, 403, 404 are selected and the L, M and R columns are advanced one symbol position each so that symbols 402, 403, 404 appear in the display (see FIG. 12) and provide further symbol combinations for determining game outcomes. One or many additional symbols may be selected in accordance with embodiments of the present invention, and may be positioned on the display by advancing the rows or columns of the display accordingly, to provide further symbol combinations.

The gaming system can take a number of different forms. In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

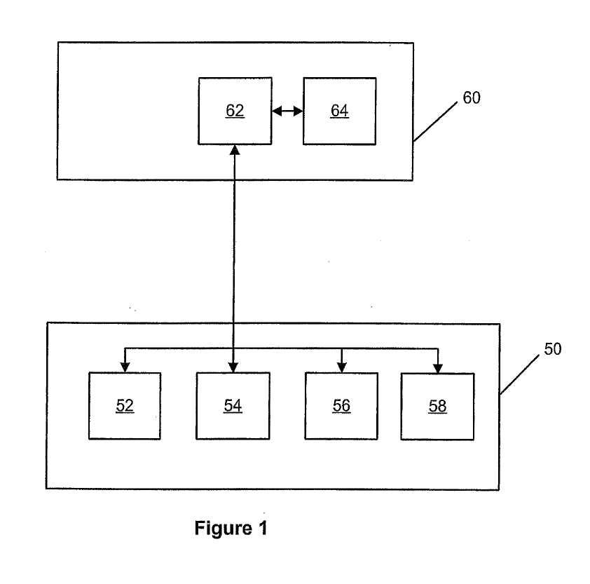

Irrespective of the form, the gaming system comprises several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions (e.g. to place bets), and one or more speakers 58.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

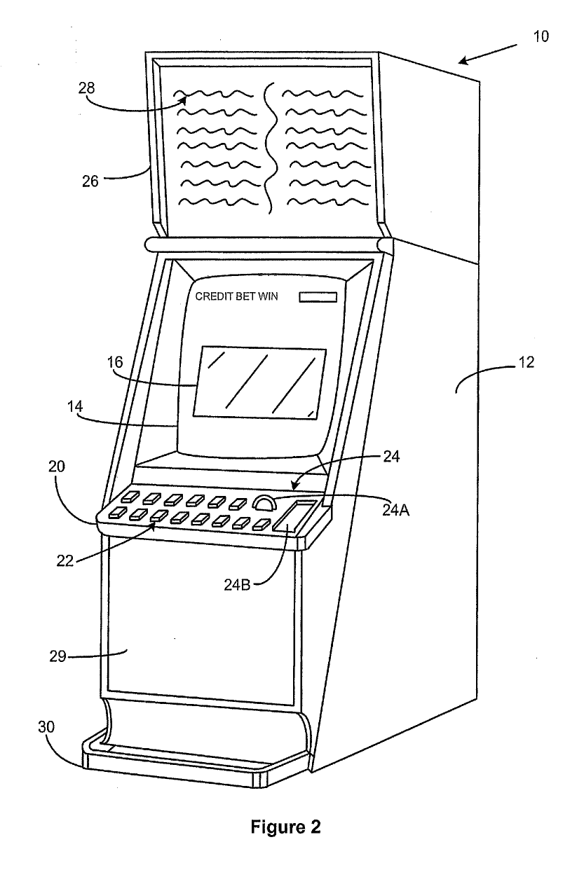

A gaming system in the form of a stand alone gaming machine 10 is illustrated in FIG. 2. The gaming machine 10 includes a console 12 having a display 14 on which are displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module (not shown) having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

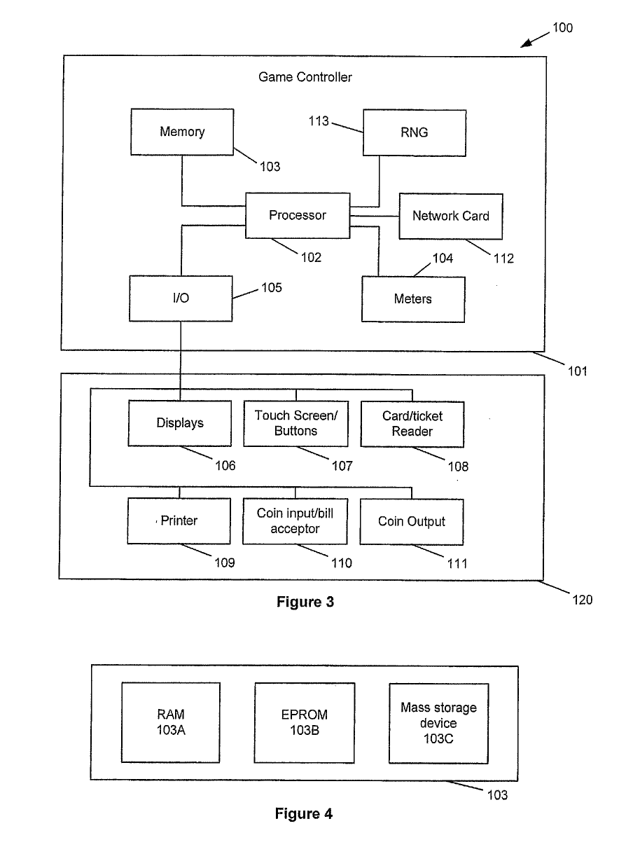

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 comprise one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 1038 or elsewhere.

It is also possible for the operative components of the gaming machine 100 to be distributed, for example input/output devices 106,107,108,109,110,111 to be provided remotely from the game controller 101.

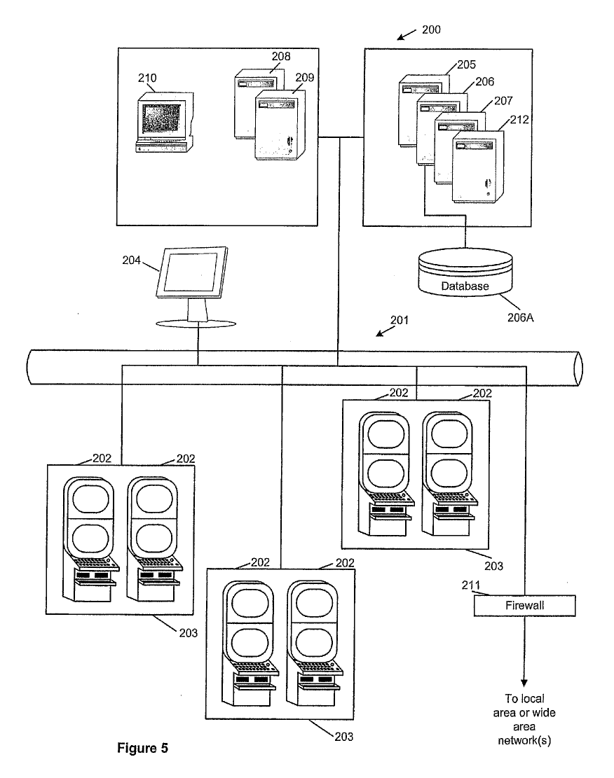

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. For example, the displays 204 may be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to perform accounting functions for the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

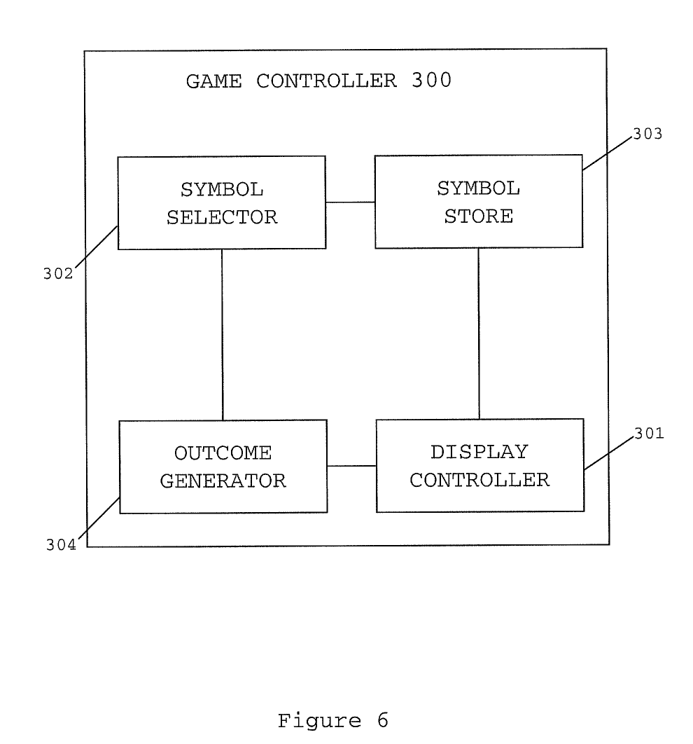

Referring to FIG. 6, the functionality of embodiments of the present invention may be implemented by a game controller having the functional components illustrated. In this embodiment, the functional components are implemented utilising a processor and memory (such as processor 102 and memory 103 in FIG. 3, or processor 62 and memory 64 in FIG. 1, for the game server 205 in FIG. 5), and associated programming. Other implementations are envisaged. For example the functional blocks of FIG. 6 may be implemented in hardware as separate units, or a combination of hardware and software as separate units. Any practical implementation of these functional units may be employed.

In this embodiment, the game controller 300 is arranged to control the gaming system to play a game which comprises a selection of a plurality of symbols from a set of symbols. The game is implemented as a “reel” game. The game controller 300 comprises a display controller 301 which is arranged to control the display (reference numerals 54, 14, 106, 204 of previous figures) to emulate a representation of reels bearing symbols. Alternatively, the display may comprise a stepper motor and physical reels bearing the symbols.

The game controller 300 includes a symbol selector 302 which is arranged to select a plurality of symbols from a set of symbols available in a symbol store 303. An outcome generator 304 is arranged to determine an outcome of the game. In this embodiment, the outcome of the game depends on the selected symbols and may include a win outcome, loss outcome, trigger outcome, a feature outcome or other outcome. Outcomes may be determined on the basis of symbols appearing in one or more horizontal lines, diagonal lines, or any other pre-determined combinations.

FIG. 7 shows a schematic representation of a gaming machine display 400 which, in the example shown, has three reels labelled “L”, “M” and “R”. The display 400 shows three reel positions high when the reels have stopped/the symbols have been selected. The reel positions are designated Bottom (“B”), Centre (“C”) and Top (“T”). This is a typical reel-type display for a gaming machine. It will be appreciated that in other embodiments the number of reel positions may be more or less than in display 400. Also the number of reels may be more or less than in the display 400.

The reels may be virtual reels, generated as a video display from the selected symbols, actual mechanical reels carrying the symbols and driven by a stepper motor, or any other reel arrangement or emulation. In the case of actual physical reels, the game controller drives a stepper motor to randomly select the symbols appearing at the display 400.

The game outcome is determined by the outcome generator 304 based on combinations of symbols selected and appearing in the display 400. The symbols may be any symbols. As will be appreciated, many different types of symbols are used in gaming systems. A set of symbols may include standard symbols and function symbols. For example, standard symbols may resemble fruit such as apples, pears and bananas with a win outcome being determined when a predetermined number of the same fruit appear on a display in the same line, scattered, and so on. The function associated with a function symbol may be a “wild” function wherein display of the function symbol is treated during consideration of the game outcome as any of the standard symbols. Other functions may include scatter functions, multiplier functions, repeat win functions, jackpot functions and feature commencement functions.

The symbols may be representations of cards, by which a poker-type card game may be played. For example, a winning poker hand appearing on the C line may cause the outcome generator to determine that a Win has occurred and that an appropriate prize may be awarded. For example, three of a kind (e.g. 3 jacks “J”. 3 tens “10” etc) on the C line may result in a win. A straight or a straight flush or any other poker combination on the C line may also result in a win.

It will be appreciated that in embodiments of the invention the symbols may be represented in different ways, using any type of fancy artwork, or in any appropriate manner.

Operation of an embodiment of the present invention will now be described, referring to FIGS. 7 through 12.

FIG. 7 shows what is known as a “3×3” display. There are three rows (T, C and B) and three columns (L, M and R) forming a 3×3 symbol matrix. This allows for a predetermined number of combinations of symbols to be used when determining game outcomes. In this embodiment, five “win lines” are shown. These are labelled in FIG. 7 as win lines 1 to 5. Win line 1 is the top horizontal row, T, win line 2 is the centre horizontal row, C, and win line 3 is the bottom row, B. Win line 4 is a diagonal line from the top left (LT) to the bottom right (RB). Win line 5 is a diagonal line from the bottom left (LB) to the top right (RT).

Another form of representation of the win lines is shown in FIG. 8.

In this embodiment, therefore, there are five win lines available to the player. The player may place a wager on one or more of these win lines and may achieve initial game outcomes based on symbol combinations of symbols positioned on one or more of these win lines. Put another way, an initial matrix of symbol combinations is displayed for determining initial game outcomes. It will be appreciated that there are a fixed number of symbol positions available in the display and therefore only a limited number of lines of symbol combinations available.

In accordance with an embodiment of the present invention, additional symbols are selected and used to determine further combinations (in this embodiment linear combinations) of symbols together with symbols appearing in the display. In other words, the additional symbols are introduced into the display (so as to vary the initial matrix of symbol combinations) to determine second game outcomes. In this embodiment three further symbols are selected to form an additional row of symbols. Referring to FIG. 9, the columns LMR are advanced one symbol position (arrow y direction) to reveal a further three selected symbols 402, 403 and 404. FIG. 12 illustrates the display after the columns LMR have been advanced (i.e. varying the initial matrix of symbol combinations). A new bottom row B of symbols, comprising the additional symbols 402, 403 and 404 now appears in the display. Further combinations of symbols are now available, in this embodiment being new lines 6, 7 and 8. Line 6 is the new bottom row B, line 7 is a diagonal from top left (LT) through bottom right (RB) in FIG. 12. Note that this diagonal is formed from the symbols that were originally at LC and MB in FIG. 7, with the additional symbol 404. Line 8 is formed by the diagonal from bottom left (BL) through top right (RT) in FIG. 8. It is formed by the symbols that were initially at RC and MB in FIG. 7 together with additional symbol 402.

By adding in the additional row of symbols 402, 403 and 404 the 3×3 gaming display effectively operates as a 3×4 gaming display, which allows three further lines of symbol combinations.

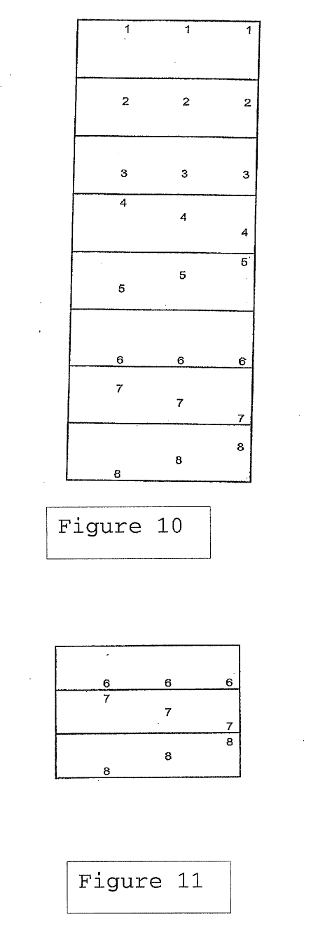

FIG. 11 is a diagrammatic representation of the three further lines. FIG. 10 shows the eight lines that are available in a 3×4 display, which this embodiment of the invention has effectively become.

In an embodiment where the gaming system comprises an actual reel and stepper motor, for example, providing the display of FIGS. 7 to 12, then the gaming system operates by selecting the symbols, driving the stepper motor to stop the reels at the standard 3×3 matrix display. Symbol combinations within the initial symbol matrix and any line wins are then calculated. Each reel is then advanced one reel position so as to vary the matrix of symbol combinations, the further combinations being determined utilizing the additional symbols. The additional symbols are the next symbols on the reel, but have now been advanced into the display.

Where the gaming system comprises a virtual reel e.g. a video reel emulating an actual reel, the symbols are selected and the virtual reel appears to rotate until the symbols appear in the display. The virtual display is then advanced one symbol to reveal the additional symbols. All the symbols on the reels may be selected at the same time as an initial selection, including the additional symbols which remain hidden until the virtual reels are advanced. Alternatively, the additional symbols may be selected separately from the selection of the initially displayed symbols.

In the above embodiment, eight win line combinations are provided. A player may wager credit on all eight win lines, including the initial lines (FIG. 7) and the further lines 6, 7 and 8 that will be spun up when the columns are advanced. This provides additional scope for enjoyable game play, more interest for the player and more chances of obtaining a win.

It will be appreciated that there may be other combinations of symbols which may be assessed, not just linear combinations as disclosed in FIGS. 7 through 12. Any pattern or combination of symbols may be utilised.

In the above example, the columns are advanced by one symbol position to provide three additional symbols in the bottom B row. The columns may be advanced more than one symbol position. For example, the columns may be advanced two symbol positions, and determinations of combinations made each time the columns are advanced (i.e. determining more combinations for each symbol position), leading to further pay lines, for example. Columns may be advanced any number of symbol positions and pay lines determined, as desired. In a further embodiment, the columns may move more than one symbol position before combinations are evaluated. In yet a further embodiment, each column could move independently, e.g. one or more symbols may be selected and only one column moved. Or two or more columns may be moved.

In the above embodiment, the columns are advanced upwardly (as shown in drawings). The advance may be in the opposite direction (i.e. the reverse of arrows Y in FIG. 9) to bring in additional symbols from the top of the display e.g. to form a new top row of the display. In yet a further embodiment it may not be the columns LMR that are advanced but it may be the rows. One or more rows may be advanced from right to left or left to right. It is also possible in some embodiments that symbols may be advanced in a diagonal direction.

It will be appreciated that the embodiment of the invention is not limited to the symbols displayed in FIGS. 7, 9 and 12 and any symbols and variations of symbols may be utilized.

In an embodiment, initial selection of the symbols and selection of the additional symbols are all carried out as part of a base game.

In an alternative embodiment, the selection of the additional symbols may only occur in a feature game. That is, the gaming system may award a feature to the player in which extra combinations are provided by the additional symbols. In yet a further embodiment, the player may “buy” additional symbols using player credit. For example, a player may decide to buy a particular number of lines, including lines that are only generated by selection of additional symbols.

In an embodiment, the selection of additional symbols does not depend on game outcomes determined by the combinations of the originally selected symbols. Combinations formed by the originally selected symbols are irrelevant as to whether or not additional symbols will be selected for forming further combinations. The additional symbols are selected in the normal course of the game.

The present invention has particular advantage where there is a limited amount of display provided by a gaming system. The present invention can be used to increase the number of combinations available, e.g. increase the number of win lines available to a player, without changing the display. Where there are definite limitations on the number of reels that can be presented to the player (due to physical cabinet size limitations for example, or other limitations) this invention may be particularly useful. Without redesigning any of the hardware in a mechanical slot machine, for example, the number of reel combinations can be extended. Similarly, for a virtual reel slot machine (video slot) with no modifications to the artwork used in the display of the symbols or to the code used to display them, the number of winning combinations can be extended. In any gaming machine, mechanical or video, the symbols can be kept larger through this invention, making them more readable and more attractive than they would be if they were reduced in size to accommodate displaying a larger number of rows within the available display space. Also, as it becomes prohibitive to display larger numbers of lines, for example 100 line games are gaining in popularity, embodiments of this invention may help extend this to 200 lines or beyond.

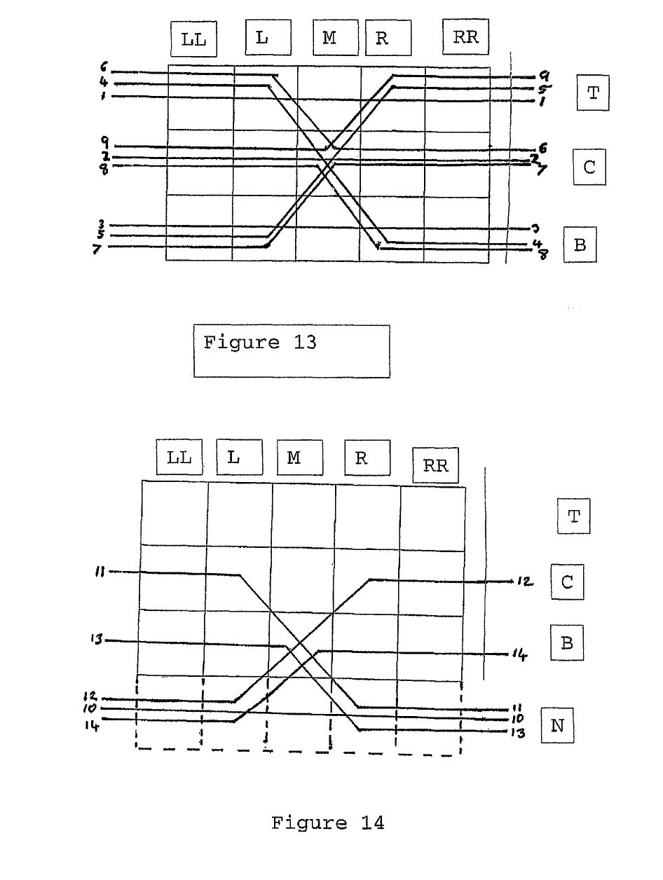

FIGS. 13 and 14 illustrate an example of a 5×3 display and how the number of combinations can be increased in accordance with an embodiment of the present invention. FIG. 13 shows a five column (LL, L, N, R, RR) and three row (T, C, B) display. Nine win lines are illustrated. The win lines combine the symbol positions in accordance with the following table.

TABLE 1

| WIN LINE | SYMBOL POSITION |
|---|---|
| 1 | LL/T; L/T; M/T; R/T; RR/T |
| 2 | LL/C; L/C; M/C; R/C; RR/T |
| 3 | LL/B; L/B; M/B; R/B; RR/B |
| 4 | LL/T; L/T; M/C; R/B; RR/B |
| 5 | LL/B; L/B; M/C; R/T; RR/T |
| 6 | LL/T; L/T; M/C; R/C; RR/C |
| 7 | LL/B; L/B; M/C; R/C; RR/C |
| 8 | LL/C; L/C; M/C; R/B; RR/B |
| 9 | LL/C; L/D; M/C; R/T; RR/T |

FIG. 13 illustrates an embodiment where each of the columns is advanced one position to bring in a row of additional symbols, in FIG. 14 designated the N row. It can be seen that a further five win lines are added by adding the N row, without it being necessary to change the display. The further five lines are given in the following table, Table 2.

TABLE 2

| WIN LINE | SYMBOL POSITION |
|---|---|
| 10 | LL/N; L/N: M/N; R/N; RR/N |
| 11 | LL/C; L/C; M/B; R/N; RR/N |
| 12 | LL/N; L/N; M/B; R/B; RR/B |
| 13 | LL/B; L/B; M/B; R/N; RR/N |
| 14 | LL/N; L/N: M/B; R/B; RR/B |

It will be appreciated that the present invention can give rise to many additional combinations of symbols to increase player interest. The invention is not limited to a 3×3 or 5×3 display, but may be applied to any display having any number and combination of symbol positions.

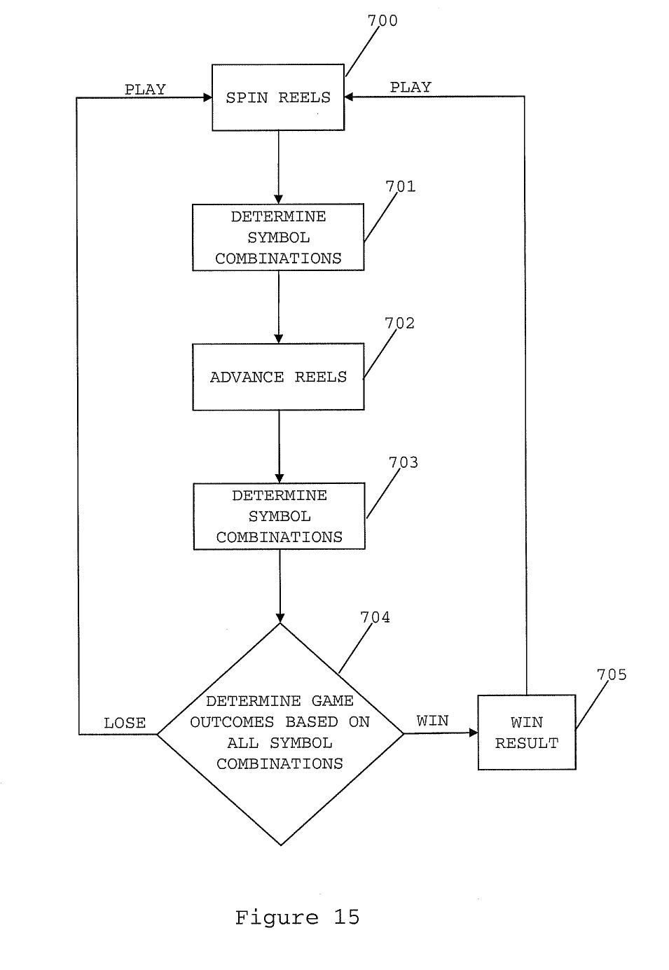

A game playing process in accordance with an embodiment of the present invention will now be summarised with reference to FIG. 15.

This game playing process relates to a gaming machine where symbols are selected and appear on a display which emulates spinning reels (a video gaming machine) or actual reels bearing the symbols and driven by a stepper motor (stepper gaming machine). At step 700, the game is played by a selection of symbols and spinning the reels. At step 701 symbol combinations are determined. It may be determined whether any award is to be made to the player on the basis of the symbol (original symbol combinations) combinations. At step 702, the reels are advanced to include additional symbols in the display. At step 703 additional symbol combinations are determined utilising the additional symbols. At step 704 game outcomes are determined based on the symbol combinations for all the symbol combinations, including those in 701 and 703. If a win outcome is determined, at step 705 a win result is awarded to the player. The player then may return to play the game again. If no win outcome is determined, the player loses and may play again.

In the above embodiment, the columns or rows are advanced to provide the additional symbols. In an alternative embodiment, combinations with selected additional symbols may be calculated, but the display may not be changed. That is the additional symbols may remain “hidden” and game outcomes using the additional symbols are calculated internally in the gaming system. This still allows for additional combinations over the combinations available from the symbol positions in the display, but does not change the display. For example, the player may bet on “hidden” symbols and the machine calculates any award.

In the above embodiments, the display is a reel type display. The invention is not limited to a reel type display and, for example, may merely be a display of a pattern of symbols in rows and columns which are not necessarily represented as reels.

In the above embodiments, the game outcomes of the combinations may be determined sequentially i.e. determined for the originally selected symbols and then for the additional symbols. Or they could be determined at the same time and player awards made at the end of the gaming sequence.

It will be appreciated that embodiments of the invention may be implemented utilising computer program code. The program code may be supplied in a number ways, for example on a computer readable medium, such as a disk or a memory (for example, that could replace part of the memory 103) or as a data signal (for example, by downloading it from a server).

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A gaming system, comprising a game controller arranged to control play of a game, and a display arranged to display a representation of play of the game, the game controller being arranged to select a plurality of symbols from a set of symbols for play of the game, and to control the display to display a plurality of the selected symbols in symbol positions in rows and columns forming an initial matrix of symbol combinations determining initial game outcomes, the game controller being arranged to advance at least one of the rows and columns of symbols to vary the matrix of symbol combinations to determine second game outcomes.

2. A gaming system in accordance with claim 1, wherein the step of advancing comprises replacing a displayed symbol with an additional symbol of the selected symbol set, to form the varied matrix of symbol combinations.

3. A gaming system in accordance with claim 1, wherein the game controller is arranged to advance at least one of the rows to display the varied matrix.

4. A gaming system in accordance with claim 1, wherein a plurality of additional symbols are displayed in symbol positions forming the varied matrix.

5. A gaming system in accordance with claim 1, wherein the display is advanced by removing one or more symbols initially appearing in the rows and columns of the display and moving one or more symbols to different symbol positions within the rows and columns.

6. A gaming system in accordance with claim 5, wherein the display is a reel display and wherein the reel is advanced by implementing motion of the reel to move at least one symbol from the display and display at least one additional symbol.

7. A gaming system in accordance with claim 6, wherein the game controller is arranged to advance all the reels by at least one reel position to display an entire row of additional symbols into the matrix of symbol combinations determining second game outcomes.

8. A gaming system in accordance with claim 1, the game controller being arranged to control the display to advance the at least one of the rows and columns by a plurality of symbol positions.

9. A gaming system in accordance with claim 7, wherein the game controller is arranged to assess symbol combinations for determining game outcomes for each symbol position advanced.

10. A gaming system in accordance with claim 1, further comprising a player interface enabling a player to make a wager associated with symbol positions in the matrix, and wherein the player interface enables the player to allocate a further wager associated with the second matrix of symbol combinations determining second game outcomes.

11. A method of gaming, comprising the steps of selecting a plurality of symbols from a set of symbols for play of a game, displaying at least a plurality of the selected symbols in symbol positions in rows and columns forming a matrix of symbol combinations for determining initial game outcomes, selecting at least one additional symbol and advancing at least one of the rows and columns displayed to introduce the additional symbol to provide a varied matrix comprising further symbol combinations determining second game outcomes.

12. A method in accordance with claim 11, wherein the step of selecting at least one additional symbol comprises selecting a plurality of additional symbols and the step of advancing includes advancing the at least one of the rows and columns to display the plurality of additional symbols.

13. A method in accordance with claim 12, wherein the plurality of additional symbols are displayed in symbol positions forming one of a row and a column.

14. A method in accordance with claim 11, wherein the step of advancing at least one of the rows and columns comprises the steps of removing one or more symbols appearing in the initial matrix and advancing one or more symbols to different symbol positions within the rows and columns to form the varied matrix.

15. A method in accordance with claim 11, wherein the step of displaying the selected symbols comprises displaying the symbols as a reel display and the step of advancing at least one of the rows and columns comprises the step of advancing at least one reel to remove at least one symbol from display and to display the at least one additional symbol.

16. A method in accordance with claim 15, wherein the step of advancing the reel in at least one of the rows and columns comprises the step of advancing all the reels by at least one reel position to display an entire row of symbols.

17. A method in accordance with claim 11, wherein the step of advancing at least one of the rows and columns displayed comprises the step of advancing the at least one of the rows and columns by a plurality of symbol positions.

18. A method in accordance with claim 17, comprising the further step of assessing symbol combinations for determining game outcomes for each symbol position advanced.

19. A method in accordance with claim 11, comprising the further step of allocating player credit against particular combinations of symbol positions, including combinations that include the at least one additional symbol.

20. A gaming system, comprising a game controller arranged to control play of a game, and a display arranged to display a representation of play of the game, the game controller being arranged to select a plurality of symbols from a set of symbols for play of the game, and to control the display to display a plurality of the selected symbols in symbol positions in rows and columns forming symbol combinations for determining game outcomes, the game controller being arranged to form further symbol combinations for determining game outcomes by combining symbols appearing in the display with selected symbols not appearing in the display.

21. A method of gaming, comprising the steps of selecting a plurality of symbols from a set of symbols for play of a game, displaying at least a plurality of the selected symbols in symbol positions in rows and columns forming symbol combinations for determining game outcomes, and forming further symbol combinations for determining game outcomes by combining displayed symbols with selected symbols not displayed.

22. A gaming system, comprising a game controller arranged to control play of a game, and a display arranged to display a representation of play of the game, the game controller being arranged to select a plurality of symbols from a set of symbols for play of the game, and to control the display to display a plurality of the selected symbols in symbol positions in rows and columns forming symbol combinations for determining initial game outcomes, the game controller being arranged to select at least one additional symbol, and to control the display to advance at least one of the rows and columns of symbols to provide a symbol position for the at least one additional symbol, to form further symbol combinations for determining game outcomes, wherein the game controller is operable to advance at least one of the rows and columns of symbols irrespective of the initial game outcomes.

23. A gaming system in accordance with claim 1, further comprising a computer program leaving instructions for controlling a computer to implement said gaming system.

24. A gaming system in accordance with claim 23, further comprising a computer readable medium for storing said computer program.

25. A gaming system in accordance with claim 23, further comprising a data signal indicative of said computer program.

26. A game controller arranged to control play of a game, the game controller being arranged to select a plurality of symbols from a set of symbols for play of the game, and to control a display to display a plurality of the selected symbols in symbol positions in rows and columns forming an initial matrix of symbol combinations determining initial game outcomes, the game controller being arranged to advance at least one of the rows and columns of symbols to vary the matrix of symbol combinations to determine second game outcomes.

27. A game controller arranged to control play of a game, the game controller being arranged to select a plurality of symbols from a set of symbols for play of the game, and to control a display to display a plurality of the selected symbols in symbol positions in rows and columns forming symbol combinations for determining game outcomes, the game controller being arranged to form further symbol combinations for determining game outcomes by combining symbols appearing in the display with selected symbols not appearing in the display.

28. A game controller arranged to control play of a game, the game controller being arranged to select a plurality of symbols from a set of symbols for play of the game, and to control a display to display a plurality of the selected symbols in symbol positions in rows and columns forming symbol combinations for determining initial game outcomes, the game controller being arranged to select at least one additional symbol, and to control the display to advance at least one of the rows and columns of symbols to provide a symbol position for the at least one additional symbol, to form further symbol combinations for determining game outcomes, wherein the game controller is operable to advance at least one of the rows and columns of symbols irrespective of the initial game outcomes.

29. A gaming system in accordance with claim 20, further comprising a computer program having instructions for controlling a computer to implement said gaming system.

30. A gaming system in accordance with claim 29, further comprising a computer readable medium for storing said computer program.

31. A gaming system in accordance with claim 29, further comprising a data signal indicative of said computer program.

32. A gaming system in accordance with claim 22, further comprising a computer program having instructions for controlling a computer to implement said gaming system.

33. A gaming system in accordance with claim 32, further comprising a computer readable medium for storing said computer program.

34. A gaming system in accordance with claim 32, further comprising a data signal indicative of said computer program.
